(19) United States
(12) Patent Application Publication
(10) Pub. No.: US 2012/0269148 A1
(43) Pub. Date: Oct. 25, 2012

(54) Methods and Devices for Switching Anchor Carrier

(75) Inventors: Johan Hultell, Solna (SE); Johan Bergman, Stockholm (SE)

(73) Assignee: Telefonaktiebolaget L M Ericsson (Publ), Stockholm (SE)

(21) Appl. No.: 13/508,647

(22) PCT Filed: Aug. 12, 2010
(86) PCT No.: PCT/SE10/50883

§ 371 Date: May 8, 2012

Related U.S. Application Data
(60) Provisional application No. 61/260,169, filed on Nov. 11, 2009.
(60) Provisional application No. 61/298,690, filed on Jan. 27, 2010.

(51) Int. Cl. H04W 72/04

(52) U.S. Cl. 370/329

(57) ABSTRACT

Methods and devices are provided whereby the primary uplink (and downlink carrier) can be dynamically changed. Embodiments are described wherein it is determine which carrier that is to be used as a new primary carrier instead of an old carrier currently being used as a primary carrier based on a criteria/trigger event. The new carrier can be signaled between the radio base station and the user equipment when switching to the new primary carrier.

### TECHNICAL FIELD

The present invention relates to methods and devices for switching primary (anchor) carrier in multi-carrier systems.

### BACKGROUND

During Release 8 (Rel-8) and Release 9 (Rel-9) several features related to Dual-Cell High Speed Packet Access (HSPA), in which a User Equipment (UE) can receive and/or transmit data simultaneously on multiple carriers also denoted frequency or carrier frequency, have been standardized in Third Generation Partnership Project (3GPP). One characteristic common to all these features is that the serving Node-B (i.e., the serving radio base station of a cellular radio network) dynamically can activate (and deactivate) part of the carriers by means of transmitting an order; typically a High Speed Shared Control Channel (HS-SCCH) order. Carriers that can be deactivated are referred to as secondary carriers while a downlink and an uplink carrier that can not be deactivated instead is referred to as being a primary (or anchor) carrier. With respect to downlink Dual Cell (i.e. Dual Carrier) High Speed Downlink Packet Access (DC-HSDPA) operation, the main motivation behind the design choice of having a primary carrier that the Node-B is unable to deactivate was that the mobility was based on this carrier only. In uplink Dual Cell (i.e. Dual Carrier) High Speed Uplink Packet Access (DC-HSUPA) operation the main reason is instead that it is only on the primary uplink carrier that High Speed Dedicated Physical Control Channel (HS-DPCCH) and non-scheduled transmissions can be transmitted. As HS-DPCCH carries the layer 1 (L1) feedback related to all downlinks carriers it is important to ensure that the UE always is capable of transmitting on its primary uplink carrier.

In Rel-8 and Rel-9 DC-HSDPA and DC-HSUPA, the radio network controller (RNC) decides which of the configured carriers that should be primary and signals this to the UE via Radio Resource Control (RRC) signaling. Similarly the Node-B is informed by the RNC via control plane e.g. Node B Application Part (NBAP)/Radio Network Subsystem Application Part (RNSAP) signaling. Albeit the Node-B dynamically can activate and deactivate the secondary carrier, the Node-B does not have any possibility to dynamically change which of the uplink carriers that should be the primary uplink (or downlink) carrier. In fact, in order to change primary carrier for a specific UE, the UE needs to be reconfigured via an inter-frequency handover (IFHO) by the RNC. Aside from being associated with considerable delays (since it involves the RNC) such reconfigurations may be undesirable for the uplink transmissions because they can:
enforce that the state of the ‘new’ secondary uplink carrier is reset to a deactivated mode. This means that the serving Node-B (subsequent to the reconfiguration) has to activate the ‘new’ secondary carrier, and
require that the Node-B scheduler resets the grants associated with the uplink carriers. This may result in increased variations for the noise rise estimates with reduced resource utilization as a consequence.

Both these two aspects are likely to cause a temporarily degraded uplink performance for the reconfigured UE itself.

Recently 3GPP has started their work on features for Release 10 (Rel-10). Within this time-frame work on 4-carrier HSDPA has been initiated. 4-carrier HSDPA enables the Node-B to transmit data on four downlink carriers to a single UE simultaneously. As for Rel-8 and Rel-9 HS-DPCCH may only be transmitted on the primary uplink carrier, i.e. L1 feedback information for all downlink carriers will be transmitted on the primary uplink carrier. In such a scenario, its relative importance will increase even further as illustrated in FIG. 3.

Furthermore, In Rel-9 DC-HSUPA one design principle has been to manage each of the activated uplink carrier independently. One example of this is that each uplink carrier has its own out-of-sync handling. Thus, if the UE estimates that the downlink Fractional Dedicated Physical Channel (F-DPCH) quality during the last 160 ms (or the last 240 slots in which Transmit Power Control (TPC) commands are known to be transmitted) is worse than a threshold it will stop transmitting on the associated uplink carrier. This is further described in section 5.1.2.2.1.1 of CR0570 of 3GPP Technical Specification TS 25.214, Introduction of DC-HSUPA, Miazaki for the details of the out-of-sync behavior for DC-HSUPA and in 3GPP Technical Specification TS25.101 v8.6.0. Base station (BS) radio transmission and reception (Release 8) for the relevant tests.

It is also noted that the F-DPCH quality may vary amongst carriers because:
The downlink carriers may be located in different frequency bands. As the propagation loss for a particular carrier increases with the carrier frequency, cell-edge UEs may experience worse F-DPCH quality for the downlink carrier(s) located in high frequency bands compared to the downlink carrier(s) located in lower frequency bands. In fact, this would be the situation in which the network is not completely interference limited.
The interference levels that the UE experiences on different downlink carriers may vary. This could, for example, be an effect of overlay architectures where micro, pico, or Home Node-Bs have been deployed on one (or a subset) of the carriers.

A highly undesirable consequence of the out-of-sync handling in DC-HSUPA is that an inferior F-DPCH quality for the downlink carrier associated with the primary uplink carrier will result in that the UE is unable to transmit the High Speed Dedicated Physical Control Channel (HS-DPCCH) information related to the primary as well as secondary downlink carriers. This will result in that the downlink transmissions are stalled—also in situations where the F-DPCH quality associated with the secondary downlink and uplink carriers are adequate. Assuming that higher layers base the status of the radio connection on the primary carrier this may even result in a radio link failure.

Another drawback with the current solution is that a switch of primary carrier (anchor switch) only can be accomplished by means of IFHO (which requires RNC involvement).

Hence there exist a need for new methods and devices providing improved switching of primary carrier (anchor switch) in a cellular network.

### SUMMARY

It is an object of the present invention to provide an improved method and device to address the problems as outlined above.

This object and others are obtained by the methods and devices as set out in the appended claims.

Thus, in accordance with the present invention methods and devices are provided whereby the primary uplink and downlink carrier can be dynamically changed.

In accordance with one embodiment, upon performing a switch of primary carrier the UE starts to transmit HS-DPCCH and non-scheduled data on the ‘new’ primary uplink frequency.

In accordance with one embodiment a primary carrier switch is performed controlled by a radio base station Node-B. In this embodiment the serving Node-B controls which of the carriers that should be the primary carrier. The radio base station can determine which carrier that is to be used as the new primary carrier based on some criteria. The new primary carrier is then signaled to the UE. In response to such a signaled message the UE switches primary carrier.

In accordance with one embodiment a primary carrier switch is performed controlled by an UE. In this embodiment the UE controls if and when a primary carrier switch should take place. The new primary carrier is then switched to by the UE. The UE then signals to the radio base station the new primary carrier. The signaling to the radio base station can take place by implicit signaling or by explicit signaling. Using an implicit signaling method the UE can use a layer 1 (L1) signal or Layer 2 (L2) Media Access Control (MAC) message, e.g., a forbidden Enhanced Dedicated Channel (E-DCH) Transmission Format Combination Indication (E-TFCI), on the secondary uplink frequency that the UE intends to start using as its ‘new’ primary uplink frequency.

Using an explicit signaling method the UE can transmit a related L1 signal or L2 MAC message on any uplink frequency and indicates which one of the secondary uplink frequencies that the UE intends to start using as its ‘new’ primary uplink frequency.

In accordance with one embodiment a primary carrier switch is performed using UE aided primary carrier switching. In this embodiment the UE informs the serving Node-B if it estimates that a primary carrier switch would be beneficial (and in such case to which carrier). Based on the available radio and hardware resources the serving Node-B then decides whether a primary carrier switch should be executed. In a sense this embodiment can be seen as a combination if the embodiments where the UE and the Node B controls the primary carrier switch.

In accordance with one embodiment a criteria/trigger event used for primary carrier switching controlled by a radio base station Node B comprises radio link quality information received from a user equipment.

For the different embodiments different methods can be used by the serving Node-B and UE to decide when a primary carrier switch is desirable.

In accordance with one embodiment a method is provided in radio base station configured to transmit to and or receive data on multiple carriers comprising a primary carrier from a user equipment. The radio base station can be configured to control which of the multiple carriers that is the primary carrier. The method can further comprise determining which carrier that is to be used as a new primary carrier instead of an old carrier currently being used as a primary carrier based on a criteria/trigger event and signaling the new primary carrier to the user equipment. Upon switching to the new primary carrier, the radio base station can in accordance with one embodiment wait a period of time and then end transmission of one or many physical channels in the old primary carrier. Hereby a simultaneous transmission of some physical channels on different carriers will take place for a period of time which can further improve the switching of primary carrier.

In accordance with another embodiment a method in a user equipment configured to transmit to and or receive data on multiple carriers comprising a primary carrier from a radio base station. The method can comprise determining which carrier that is to be used as a new primary carrier instead of an old carrier currently being used as a primary carrier based on a criteria/trigger event, and signaling the new primary carrier to the radio base station. Upon switching to the new primary carrier the user equipment can in accordance with one embodiment wait a period of time and then end transmission of one or many physical channels in the old primary carrier. Hereby a simultaneous transmission of some physical channels on different carriers will take place for a period of time which can further improve the switching of primary carrier.

The invention also extends to User Equipments and a radio base stations Node B arranged to perform primary carrier switching in accordance with the above methods. To enable the primary carrier switching the User Equipment and radio base station Node B can be provided with a controller for performing the above processes. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawing, in which:

FIG. 1 is a view illustrating different scenarios where the Node-B dynamically assigns the primary uplink carrier based on the UE's path gain,

FIG. 2 is a view illustrating dynamical balancing of the number of UEs that has a certain carrier as their primary uplink carrier,

FIG. 3 is a view illustrating L1 feedback information for all downlink carriers transmitted on the primary uplink carrier,

FIGS. 4a and 4b is a view illustrating exemplary control signaling from a radio base station to a UE for switching primary carrier in the UE,

FIG. 5 is a general view of a cellular radio system,

FIG. 6 is a flowchart illustrating steps performed when switching primary carrier under control by a radio base station, and

FIG. 7 is a flowchart illustrating steps performed when switching primary carrier under control by a user equipment.

FIG. 8 is a flowchart illustrating steps performed when switching anchor carrier.

### DETAILED DESCRIPTION

In accordance with embodiments of the invention a fast primary carrier switch mechanism is provided. Introducing the possibility of fast primary carrier switches where, e.g., the serving Node-B is responsible for deciding which of the carriers that should be the primary carrier is beneficial for a number of reasons including that:
It allows the Node-B to dynamically balance the number of UEs that has a certain carrier as their primary uplink carrier as is illustrated in FIG. 2. In FIG. 2 it is seen that initially there is an unbalance between the number of UEs (or load caused by UEs) that use a first carrier as primary carrier compared to the number that use a second carrier as primary carrier. By providing a fast and dynamic switching the number of UEs that use the different carriers as primary carrier can be made more even as is seen to the right in FIG. 2. This will improve the load balancing efficiency.
It enables the serving Node-B to dynamically assign the primary uplink carrier based on the UE's path gain. This can be beneficial because:
   Cell-edge UEs could then always utilize the carrier frequency with favorable propagation conditions (in a potential DB-DC-HSUPA scenario)
   The network can operate the different uplink carriers at different noise rise thresholds (i.e. one of the two uplink carriers is operated at higher noise rise threshold than the other).

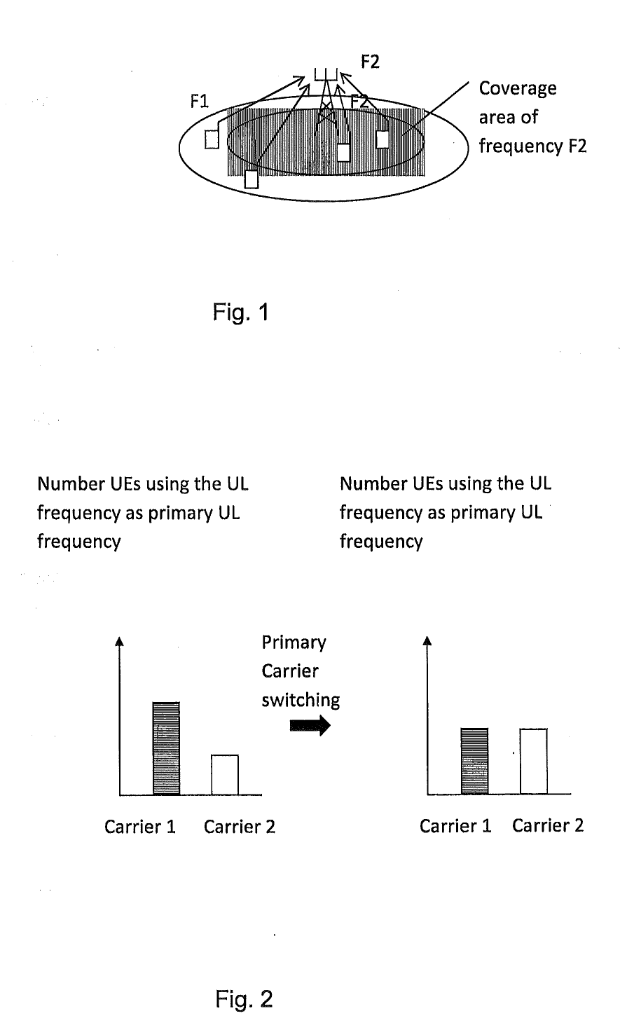

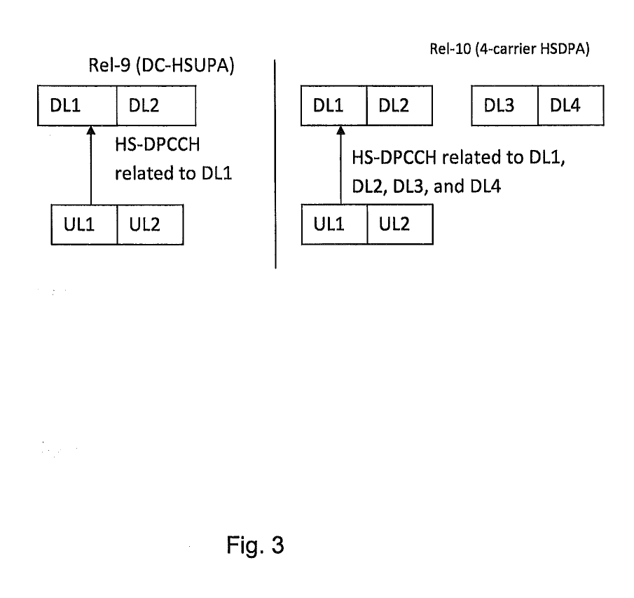

These two scenarios are illustrated in FIG. 1. In FIG. 1 a scenario is depicted where the different uplink carriers have different coverage. This can be an effect of that noise rise thresholds that can be measured as the Rise over Thermal (RoT) of the two uplink frequencies, here denoted F1 and F2 are different (in this case RoT_{F2}>RoT_{F1}), that the carrier frequencies of the two uplinks are different (in this case F2<F1), or combinations thereof. All UEs in this example would have both F1 and F2 configured.

The exemplary description in the following sections uses an exemplary configuration where the UE has two adjacent uplink carriers configured and four configured downlink carriers are spread over at most two frequency bands. However, it is understood that the invention and embodiments thereof are applicable also to scenarios where the UE can transmit on more than two uplink frequencies possibly non-adjacent within the same band or spread over multiple frequency bands. Similarly the invention and embodiments thereof are also applicable in situations where the UE has more (or less) than four downlink carriers configured possibly spread over more than two frequency bands.

Further, the below description uses the UTRA FDD HSPA (UMTS Terrestrial Radio Access Frequency Division Duplex High Speed Packed Access) standard as an example. But the invention is equally applicable to other standards with multi-carrier operation, e.g. UTRA Time Division Duplex (TDD) HSPA and E-UTRA (LTE-Advanced).

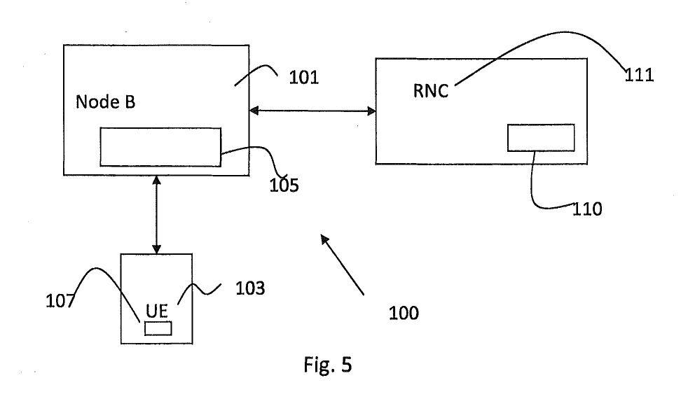

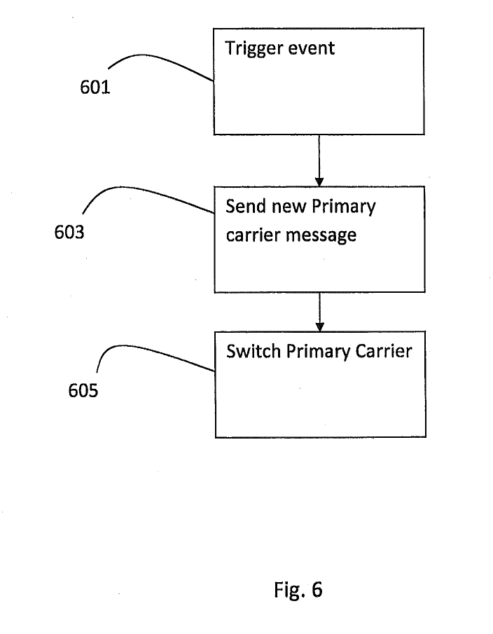

In FIG. 5 a general view of a cellular radio system 100 configured to transmit data using multiple carriers is depicted. The system 100 comprises a number of base stations 101, whereof only one is shown for reasons of simplicity. The base station 101 can connect to user equipments in the figure represented by the UE 103 located in the area served by the base station 101. The base station and the user equipment further comprise controllers 105 and 107, respectively to switch primary carrier. The controllers 105 and 107 can for example comprise suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media.

The base station 101 is further connected to a central control node 111 such as a radio network controller (RNC). The central control node 111 comprises controlling logic 110 adapted to communicate with the radio base station 101, with other radio base stations connected to the central control node 111 and with other central control nodes (not shown).

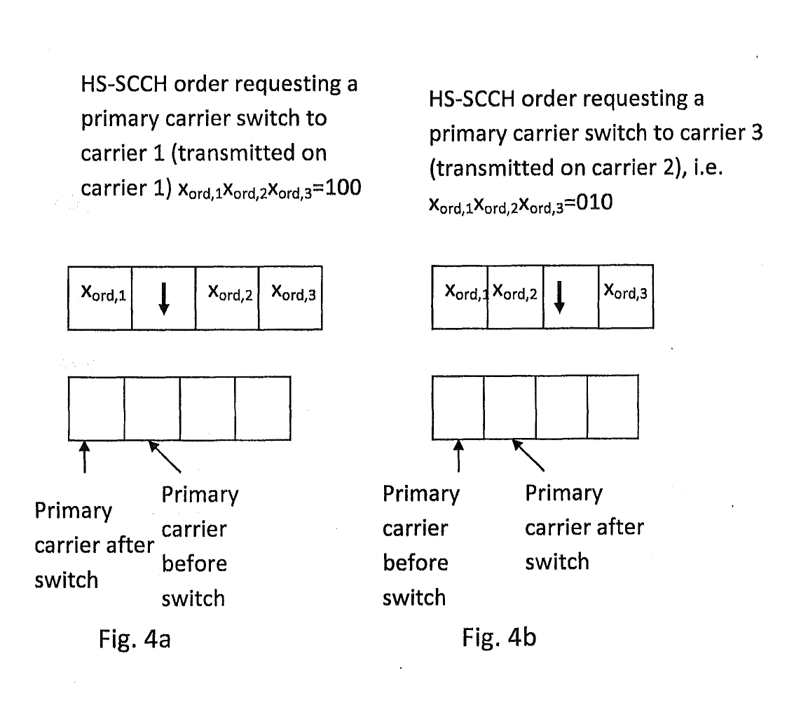

In accordance with a first embodiment, primary carrier switching is controlled by the radio base station Node B. The serving Node B can be configured to order a UE to perform a primary carrier switch by sending an order, for example a HS-SCCH order on one of the activated downlink carriers. To signal which of the carriers that should become the new primary carrier the following exemplary methods can be used:
The HS-SCCH order is transmitted on the downlink carrier associated with the uplink carrier that should become the ‘new’ primary carrier after the primary carrier switch.
The order bits in the HS-SCCH order are used to convey which carrier that should become primary carrier after the primary carrier switch. Unlike the method described above this allows the Node-B to transmit the HS-SCCH order on any activated downlink carrier. Several ways for coding the order bits are possible. For example:
   One method is to code the order bits with respect to the downlink carrier on which the order is transmitted. To exemplify, if the HS-SCCH order for primary carrier switch is transmitted on downlink carrier 2 and it contains the following set of order bits x_{order,1}x_{order,2}x_{order,3}=100 then the uplink carrier associated with downlink carrier 1 is the ‘new’ primary uplink carrier. An example illustrating the principle of the described signaling is shown in FIG. 4a
   Another method is to use binary coding of the order bits. Assuming that x_{order,3} is the least significant bit (LSB) then the combination of x_{order,1}x_{order,2}x_{order,3}=001 would convey the information that the UE should start to use the uplink carrier corresponding to downlink carrier 1 as ‘new’ primary uplink frequency. Similarly the combination of x_{order,1}x_{order,2}x_{order,3}=010 would give that the UE should start using the uplink carrier corresponding to the downlink carrier 2 as ‘new’ primary uplink carrier. This is shown in FIG. 4b.
   Yet another method is to combine the two above methods to increase the robustness (i.e. if the Node-B transmits the HS-SCCH order on downlink carrier 2, then the order bits must be equal to x_{order,1}x_{order,2}x_{order,3}=010 in order for the UE to consider the order as valid).

It is to be noted that the coding schemes assumed here also can be restricted to the carriers within a certain frequency band. In this case the HS-SCCH order can be transmitted on a downlink carrier that is in the same the frequency band as the ‘new’ primary uplink carrier.

As mentioned above, Rel-8 (DC-HSDPA) and Rel-9 (DC-HSUPA) allow the serving Node-B to activate (and/or deactivate) the secondary carrier(s) dynamically. If the UE is not in soft handover (SHO) the deactivation and activation can be performed without RNC involvement. In such a scenario it is possible for the serving Node-B to switch the primary carrier with one of the secondary carriers. In a scenario where the RNC needs to be kept aware of which carrier that currently is the primary uplink (and downlink) the serving Node-B can be configured to—after it has changed the primary carrier and with a secondary carrier—send a message to inform the RNC about the primary carrier change that has been performed. The RNC can further be configured to forward this message to the non-serving Node-Bs. This will be significantly faster than relying on an RNC reconfiguration (e.g. IFHO) since the Node-B first can change primary uplink carrier and then, once the primary carrier switch has been acknowledged by the UE, inform the RNC.

For UEs in soft handover (SHO), non-serving Node-Bs can for example be informed of the primary carrier switch by means of:
Signaling over the lub/lur interface(s) where the serving Node-B transmits a message to the RNC that a primary carrier switch has occurred. The RNC can be configured to then forward the message to non-serving Node-Bs. A similar mechanism whereby the serving Node-B informs the RNC, which in turn forwards the message to the non-serving Node-Bs, that an activation (or deactivation) of secondary uplink frequencies already exists in Rel-9.
Signaling over the Uu interface where the UE indicates that a primary carrier switch has occurred to non-serving Node-Bs by transmitting an indication in the physical layer (Layer 1) or in the MAC layer (Layer 2). In one embodiment, the UE transmits a specific E-DCH Transmission Format Combination Indication (E-TFCI) on the uplink carrier that has become the ‘new’ primary uplink frequency. As DC-HSUPA potentially any extensions to Multi Carrier (MC) HSUPA only is supported in combination with MAC-i/is there exists a set of E-TFCIs that are forbidden, see section B.1, B2, B2a, and B2b in Annex B of 3GPP TS 25.321 v8.6.0. Medium Access Control (MAC) protocol specification (Release 8). These can therefore be reused for this purpose.

The two methods described above can be combined in order to obtain both the robustness of the lub/lur signaling and the speed of the Uu signaling.

A primary carrier switch can be triggered by the Node-B as a result of a suitable trigger event. Suitable trigger events can be that:
A signal quality, for example the DPCCH quality (e.g. as measured by, Bit Error Rate (BER), Signal to Interference plus Noise Ratio (SINR) or SINR error), associated with the primary uplink frequency is worse than a particular threshold for a particular time-period.
A signal quality, for example the DPCCH quality, associated with the primary uplink frequency is below a threshold for a time-period at the same time as the DPCCH quality associated with one or more of the other uplink frequencies exceed a threshold in the case where multiple uplink frequencies are activated.

Node-B trigger events such as the ones described above can be used to ensure that a primary carrier switch is triggered before the UE is forced to stop transmitting on the primary uplink carrier because downlink synchronization has been lost for the corresponding downlink carrier.

Moreover, a primary carrier switch can be triggered for other reasons, for example because:
The uplink power headroom (UPH) associated with the primary uplink carrier is below a threshold for a certain time-period.
The UPH associated with the primary uplink carrier is below a threshold for a time-period and the UPH associated with at least one of the other uplink carriers exceeds a threshold in the case where multiple uplink frequencies are activated.
The Channel Quality Indicator (CQI) associated with the primary downlink carrier is below a particular threshold while the CQI associated with one of the secondary downlink carriers is above another CQI threshold for a particular time-period.
The Node-B receives a large number of TPC UP commands on the primary uplink carrier. Since the TPC commands are used to control the power with which the Node-B transmits F-DPCH, these can be used as an estimate the instantaneous F-DPCH quality perceived by the UE on the associated downlink carrier. Since the UE's synchronization status further is based on the F-DPCH quality on the downlink carrier this is relevant information to consider when determining whether to order a primary carrier switch.
The difference between the number of TPC UP commands that the Node-B receives on the primary uplink and the number of TPC UP commands that it receives on the secondary downlink carriers exceeds a threshold for at least one of the secondary downlink carriers. By comparing the uplink carriers with each other, the Node-B can minimize the effect of the path loss.

The first two trigger events above can be used by the Node-B to dynamically balance the number of UEs that have the different carriers as primary uplink carrier. For example the different carriers can be evenly distributed between the UEs as primary carriers. Such functionality may be valuable because it increases the gains that can be achieved by load balancing (based on deactivation of secondary uplink carriers). Extensions where the Node-B combines the UPH information with noise rise estimations and/or the available hardware resources are also possible. The CQI information can be used for ensuring that cell-edge UEs have a particular primary uplink carrier (e.g., the carrier associated with the lower carrier frequency). The last two trigger events can be used by the Node-B to ensure that a primary carrier switch is triggered when there is a risk that the UE is forced to stop transmitting on the primary uplink carrier because downlink synchronization is lost for that carrier.

In FIG. 6 a flowchart illustrating some steps performed when a radio base station is configured to control which of the carriers that should be the primary (anchor) carrier is shown. The radio base station can determine which carrier that is to be used as the new primary carrier based on some criteria/trigger event, step 601. The new primary carrier is then signaled to the UE in a step 603. In response to such a signaled message transmitted from the radio base station and received by the UE, the UE and radio base station switches to the new primary carrier in a step 605.

In accordance with a second embodiment the UE (rather than the serving Node-B) is configured to control if and whereto an uplink primary carrier switch should take place. To indicate that it performs a primary carrier switch the UE can be configured to utilize the E-TFCIs that it is prohibited from using when it is configured with MAC-i/is. As an uplink primary carrier switch only can take place when a UE is configured with multiple uplink frequencies this method can be used by all relevant UEs (since MC-HSUPA UEs can be assumed to support MAC-i/is).

There can be some advantages compared to Node-B controlled primary carrier switching:
The UE is aware of F-DPCH quality associated with the downlink carriers.
The UE can react faster than the serving Node-B when, e.g., the F-DPCH quality starts to deteriorate.
The UE is aware of the DPCCH power used on the different carriers as well as its buffer status (whereas the Node-B is only aware of this information through the scheduling information which is based on time averages).

For scenarios where the UE only has two uplink carriers configured the E-TFCI can be transmitted on any of the two uplink frequencies and the network can simply interpret the message as an indication that the UE will start to utilize the secondary uplink frequency as its primary one. For a scenario where UEs can be configured with more than two uplink frequencies (and hence more than one secondary downlink frequency) information about which of the uplink frequencies that should become the ‘new’ primary carrier can be conveyed by:
Implicit signaling, i.e. the UE transmits the related L1 signal or L2 MAC message (e.g., a forbidden E-TFCI as mentioned above) on the secondary uplink frequency that the UE intends to start using as its ‘new’ primary uplink frequency
Explicit signaling, i.e. the UE transmits the related L1 signal or L2 MAC message on any uplink frequency and indicates which one of the (secondary) uplink frequencies that the UE intends to start using as its ‘new’ primary uplink frequency. This could for example be achieved by introducing a one-to-one mapping between the forbidden E-TFCIs and possible (secondary) uplink frequency.

The following exemplary methods can be used by the UE to trigger a primary carrier switch:
F-DPCH quality associated with the primary downlink carrier is worse than a threshold during a time-period.
F-DPCH quality associated with the primary downlink carrier is worse than threshold during a time-period and the F-DPCH quality of at least one secondary downlink carrier exceeds a threshold.

The above two methods can be used to get the UE to do an uplink primary carrier switch when it is about to lose synchronization on the downlink carrier corresponding to the primary uplink carrier.

I addition the following trigger events can be used by the UE for triggering a primary carrier switch:
DPCCH power associated with the primary carrier is above a threshold for a time-period.
The difference in DPCCH power used on the primary uplink carrier and at least one of the other uplink carriers is larger than a threshold for a particular time-period.
The difference in the reported CQI values for downlink carrier associated with the primary uplink frequency and at least one downlink that has a corresponding uplink frequency configured is larger than a threshold for a certain time-period.
The DPCCH power associated with the primary carrier is larger (smaller) than a threshold for a time-period and the difference in DPCCH power used on the primary uplink carrier and the DPCCH power used on at least one of the secondary uplink carriers is larger than a threshold. Note that the case where the DPCCH power on the primary carrier is required to be larger than a threshold can be used to switch primary carrier for UEs located at the cell border while the case where the DPCCH power is required to be smaller than a threshold can be used for switching primary carrier for UEs located close the Node-B.

The above trigger events can be used by UEs to perform a primary carrier switch in situations in which the uplink coverage of the carriers differs (e.g., due to that the uplink carriers are operated at different noise rise levels or because the one of the two uplink carriers uses a lower carrier frequency).
The difference in serving grants (SGs) between the primary uplink carrier and at least on of the carriers is larger (smaller) than a threshold for a time period. This trigger can be used for increased load-balancing.

The above trigger event can be used to increase the load-balancing gains (associated with deactivation of the secondary carrier). It is to be noted that the conditions mentioned above can be combined with each other and/or the Total E-DCH Buffer Status (TEBS) to create other triggers. The TEBS contains a quantified value describing the total amount of data available in the logical buffers (in bytes), see] 3GPP TS 25.321 v8.6.0. Medium Access Control (MAC) protocol specification (Release 8).

It is further noted that serving Node-B may not be aware that the UE has conducted the primary carrier switch if the UE for example is in SHO and the MAC packet (e.g., containing one of the forbidden E-TFCIs) only is successfully received by the non-serving Node-B. One way to mitigate the effects of this is that the UE is configured to transmit the L2 MAC packet multiple times.

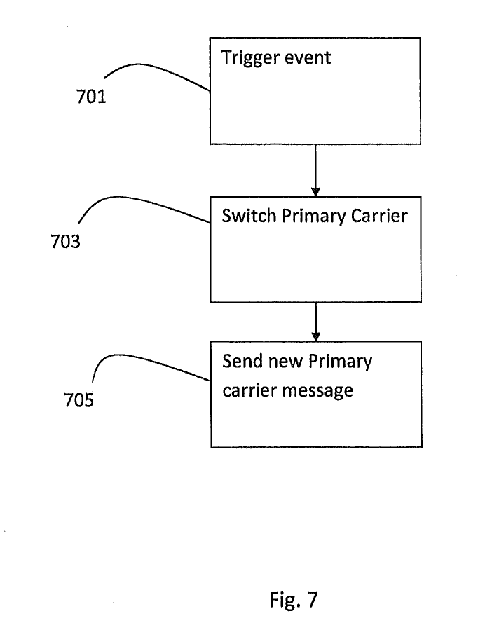

In FIG. 7 a flowchart illustrating some steps performed when a user equipment is configured to control which of the carriers that should be the primary (anchor) carrier is shown. The user equipment can determine which carrier that is to be used as the new primary carrier based on some criteria/trigger event, step 701. The new primary carrier is then switched to by the UE in a step 703. The UE then signals to the radio base station the new primary carrier in a step 705.

In a hybrid of the two embodiment described above in conjunction with FIGS. 6 and 7 the UE can be configured to send information to the radio base station informing the serving Node-B that it can be beneficial to switch primary carrier. This can be indicated by transmitting a L2 MAC message as discussed above and it can be based on the related trigger events as described above in conjunction with the second embodiment. Based on the available radio and hardware resources the serving Node-B can then decide whether a primary carrier switch would be beneficial from a system perspective by considering the mechanisms that were mentioned in relation to the first group of embodiments. Hereby both a rapid switch can be achieved and at the same time consideration to information not known to the UE can be taken into account when determining to switch primary carrier. Thus, instead of switching directly to a new primary carrier as in step 703, the UE waits for an order from the radio base station, such as an order described in step 603, before switching to a new primary carrier.

The improved performance of cellular radio systems with multiple carriers achieved with methods and devices as described above may come at a certain cost in terms of robustness if the primary carrier switch is not synchronized between the UE and the serving and non-serving Node-Bs. If HS-DPCCH and/or non-scheduled traffic is moved from one carrier to another carrier abruptly, it may take some time before the transmission on the new carrier can be received with the same performance as on the old carrier, i.e. there may be a certain time period with transient behavior. Furthermore, if the performance on the primary carrier is beginning to deteriorate, it may be beneficial to perform a relatively quick anchor switch, but on the other hand a quick anchor switch may not allow for the time the would be needed to perform a completely synchronized anchor switch.

To further improve the switching of primary carrier simultaneous transmission can be performed of physical channels that will be transmitted on other carrier(s) due to the switch on the old and the new primary carrier during a certain period of time.

When an uplink primary carrier switch is performed, a number of physical channels will move from one carrier to another. For example High Speed Dedicated Physical Control Channel (HS-DPCCH) will move in the in the uplink and, in case the uplink anchor carrier and downlink anchor carrier are paired, also Fractional DPCH (F-DPCH), E-DCH Absolute Grant Channel (E-AGCH), E-DCH Relative Grant Channel (E-RGCH) and E-HICH in the downlink.

In accordance with one embodiment, when an uplink primary carrier switch is performed one or many of the uplink channel being moved as a result of the primary carrier switch will continue in the old primary carrier and start transmitting in the primary carrier while still being active in the old primary carrier. As a result one or many of the channels, in particular physical channels will co-exist for some time in both the old primary carrier and the new primary to which the switch has been performed.

In one embodiment, the transmission of the HS-DPCCH will not stop in the old primary carrier at the same time as it starts on the new primary carrier, but exists simultaneously on both carriers for a certain period of time. HS-DPCCH is only received by the serving NodeB, as opposed to other physical uplink channels such as DPCCH, DPDCH, E-DPCCH, E-DPDCH which can be in soft handover over one or more non-serving NodeBs. Since HS-DPCCH is only received by the serving NodeB, there is no need from HS-DPCCH reception point of view to coordinate the primary carrier switch with non-serving NodeBs.

The simultaneous transmission in both the old and new primary carrier can be configured to begin when the primary carrier switch initiated and continue for a period of time that can be either
predefined in the standard, or
configurable by higher layers via a parameter in the RRC/NBAP protocols, or
decided dynamically from the serving NodeB using Layer 1/Layer 2 (L1/L2) signaling (e.g. HS-SCCH orders), or
decided by some termination condition, e.g. when a Signal to Interference plus Noise Ratio (SINR) threshold or BER threshold has been reached.

In one embodiment, not only the HS-DPCCH but also one or more associated downlink control channel (F-DPCH, E-AGCH, E-RGCH and E-HICH) will be transmitted on both the old and the new primary carrier for a certain period of time, either only from the serving NodeB or also from non-serving NodeBs.

In yet another embodiment, not only the HS-DPCCH but also non-scheduled Enhanced Dedicated Channel (E-DCH) traffic is taken into account. A non-scheduled E-DCH channel may be used to carry e.g. a Signaling Radio Bearer (SRB) or voice traffic. During the primary carrier switch, the same non-scheduled E-DCH can be transmitted on two uplink carriers simultaneously for a certain period of time. The network may prepare for this by configuring two parallel non-scheduled E-DCH channels in serving and non-serving NodeBs and in the affected network internal interfaces between networks nodes, i.e. over the lub/lur interfaces.

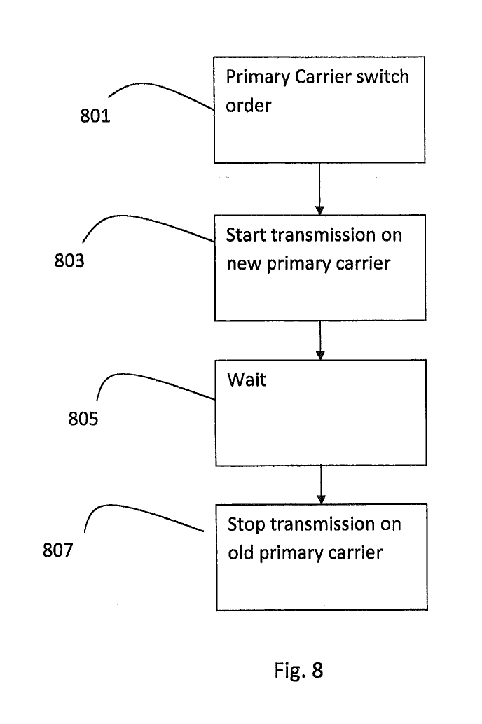

In FIG. 8, a flow chart illustrating some steps performed when switching anchor carrier using simultaneous transmission in old a new primary carrier is depicted. First in a step 801 an order to initiate an anchor switch is generated. In response to such an order in step 801 transmission in the new primary carrier is initiated in a step 803. Next, in a step 805 the procedure waits for a time period. When the waiting time in step 805 has ended, the transmission in the old primary carrier is ended. The channels that are moved in the manner described in conjunction with

FIG. 8 can in particular be the channels set out above. The steps illustrated in FIG. 8 can be performed both when the primary carrier switch is controlled by the UE and when the primary carrier switch is controlled by the radio base station.

The methods in accordance with the above can be software implemented and stored as computer program instruction segments on a memory that when executed by a computer such as a microcontroller or a micro processor will cause a device to execute the procedure.

Using the method and devices as described herein will provide several advantages. These include the UE is allowed to keep receiving downlink data in situations where the UE loses downlink synchronization on the primary uplink and where it has downlink synchronization on at least one other downlink carrier with a corresponding uplink carrier. It improves the radio resource utilization efficiency since it enables: Fast load balancing, that UEs transmit HS-DPCCH on the carrier with lowest carrier frequency (best propagation conditions) when they approach the cell edge and that one of the uplink carriers is operated at a higher noise rise (with respect to the other uplink carrier). Also triggering a radio link failure (RLF) when it is possible to transfer downlink and uplink data on another carrier is avoided.

1. A method in a radio base station configured to transmit and/or receive data on multiple carriers to communicate with a user equipment, the multiple carriers comprising a primary carrier, the radio base station controlling which of the multiple carriers is the primary carrier, the method comprising the steps of:
determining which carrier is to be used as a new primary carrier instead of an old carrier currently being used as a primary carrier based on a criteria/trigger event;
signaling the new primary carrier to the user equipment; and
switching to the new primary carrier to transmit and/or receive data communications with the user equipment.

2. The method according to claim 1, further comprising the step of:
upon switching to the new primary carrier, waiting a period of time and then ending transmission of one or many physical channels in the old primary carrier.

3. The method according to claim 1, wherein the criteria/trigger event is determined from information received from the user equipment.

4. The method according to claim 3, wherein the criteria/trigger event is determined from radio link quality information received from the user equipment.

5. The method according to claim 4, wherein the radio link quality information comprises one or many of Dedicated Physical Control Channel, DPCCH, quality or uplink power headroom.

6. A method in a user equipment configured to transmit and/or receive data on multiple carriers froth to communicate with a radio base station, the multiple carriers comprising a primary carrier, the method comprising the steps of:
determining which carrier that is to be used as a new primary carrier instead of an old carrier currently being used as a primary carrier based on a criteria/trigger event; and
signaling the new primary carrier to the radio base station.

7. The method according to claim 6, wherein the criteria/trigger event is determined based on the Fractional Dedicated Physical Channel, F-DPCH, quality measured on one or more downlink carriers.

8. The method according to claim 6, further comprising the step of:
switching to the new primary carrier to transmit and/or receive data communications with the radio base station.

9. The method according to claim 6, further comprising the step of:
switching to the new primary carrier when receiving an order from the radio base station.

10. The method according to claim 8, further comprising the step of:
upon switching to the new primary carrier waiting a period of time and then end ending transmission of one or many physical channels in the old primary carrier.

11.-12. (canceled)

13. A radio base station configured to transmit to and or and/or receive data on multiple carriers to communicate with a user equipment, the multiple carriers comprising a primary carrier, the radio base station being arranged to control which of the multiple carriers that is the primary carrier, the radio base station comprising:
a controller arranged to determine which carrier is to be used as a new primary carrier instead of an old carrier currently being used as a primary carrier based on a criteria/trigger event, and to signal the new primary carrier to the user equipment, wherein the controller is further arranged to switch to the new primary carrier to transmit and/or receive data communications with the user equipment.

14. The radio base station according to claim 13, wherein the controller is further arranged to wait a period of time and then end transmission of one or many physical channels in the old primary carrier upon performing a switch to the new primary carrier.

15. The radio base station according to claim 13, wherein the criteria/trigger event is determined from information received from the user equipment.

16. The radio base station according to claim 15, wherein the criteria/trigger event is determined from radio link quality information received from the user equipment.

17. The radio base station according to claim 16, wherein the radio link quality information comprises one or many of Dedicated Physical Control Channel, DPCCH, quality or uplink power headroom.

18.-19. (canceled)

20. A user equipment configured to transmit to and or and/or receive data on multiple carriers to communicate with a radio base station, the multiple carriers comprising a primary carrier, the user equipment comprising:
a controller arranged to determine which carrier is to be used as a new primary carrier instead of an old carrier currently being used as a primary carrier based on a criteria/trigger event, and to signal the new primary carrier to the radio base station.

21. The user equipment according to claim 20, wherein the criteria/trigger event is determined based on the Fractional Dedicated Physical Channel, F-DPCH, quality measured on one or more downlink carriers.

22. The user equipment according to claim 20, wherein the controller is further arranged to switch to the new primary carrier to transmit and/or receive data communications with the radio base station.

23. The user equipment according to claim 20, wherein the controller is further arranged to switch to the new primary carrier when receiving an order from the radio base station.

24. The user equipment according to claim 22, wherein the controller is further arranged to wait a period of time and then end transmission of one or many physical channels in the old primary carrier upon performing a switch to the new primary carrier.

25.-26. (canceled)
